(19) United States
(12) Patent Application Publication
(10) Pub. No.: US 2025/0303397 A1
(43) Pub. Date: Oct. 2, 2025

(54) PLASMONIC NANO-ALLOY PHOTOTHERMAL-COUPLED METHANE DRY REFORMING CATALYST, PREPARATION METHOD THEREFOR, AND APPLICATION THEREOF

(71) Applicant: NANJING UNIVERSITY OF AERONAUTICS AND ASTRONAUTICS, Jiangsu (CN)

(72) Inventors: Xianglei LIU, Jiangsu (CN); Nan SUN, Jiangsu (CN); Yimin XUAN, Jiangsu (CN)

(73) Assignee: NANJING UNIVERSITY OF AERONAUTICS AND ASTRONAUTICS, Jiangsu (CN)

(21) Appl. No.: 19/095,038

(22) Filed: Mar. 31, 2025

Related U.S. Application Data
(63) Continuation of application No. PCT/CN2024/089695, filed on Apr. 25, 2024.

(30) Foreign Application Priority Data
Mar. 26, 2024 (CN) 202410348334.1

(51) Int. Cl. B01J 23/80; B01J 23/00; B01J 23/02; B01J 35/39; B01J 37/00; B01J 37/02; B01J 37/03; B01J 37/04; B01J 37/06; B01J 37/10; B01J 37/18; B01J 37/34; C01B 3/40

(52) U.S. Cl. CPC B01J 23/80; B01J 23/005; B01J 23/02; B01J 35/39; B01J 37/0036; B01J 37/009; B01J 37/0236; B01J 37/033; B01J 37/04; B01J 37/06; B01J 37/10; B01J 37/18; B01J 37/343; C01B 3/40; C01B 2203/0238; C01B 2203/0805; C01B 2203/1058; C01B 2203/1076; C01B 2203/1082; C01B 2203/1241

(57) ABSTRACT

Disclosed are a plasmonic nano-alloy photothermal-coupled methane dry reforming catalyst, a preparation method therefor, and application thereof, wherein the catalyst includes a ternary nano metal component and a magnesium-aluminum spinel, and can be used for directly converting greenhouse gases to fuel. The catalyst can absorb ultraviolet-visible light irradiated by an external xenon lamp in a photothermal reactor, and use thermal radiation to reach a temperature required for a thermal catalysis, thereby achieving higher solar-to-fuel conversion efficiency. Due to extremely high solar spectrum absorptivity, the catalyst has excellent performance, and is capable of using the visible light band to excite a plasmonic effect to pre-activate gas molecules 10 for the reaction, thereby reducing apparent activation energy under direct lighting, inhibiting the complete cracking of methane and avoiding the formation of carbon deposition, such that the stability of the methane dry reforming reaction and efficiency of the reaction are improved.

### CROSS-REFERENCE TO RELATED APPLICATION

This application is a continuation of international application of PCT application serial no. PCT/CN2024/089695, filed on Apr. 25, 2024, which claims the priority benefit of China application no. 202410348334.1, filed on Mar. 26, 2024. The entirety of each of the above-mentioned patent applications is hereby incorporated by reference herein and made a part of this specification.

### TECHNICAL FIELD

The present disclosure relates to catalysts and use thereof, and particularly relates to a plasmonic nano-alloy photothermal-coupled methane dry reforming catalyst, a preparation method therefor, and application thereof.

### BACKGROUND OF RELATED ART

Since global population and energy demand are continuously increasing, a growth rate of greenhouse gases, mainly carbon dioxide (CO₂) and methane (CH₄), in atmosphere has reached a highest level in history, which severely threatens the sustainable development of human being. Therefore, how to effectively address the problem of excessive greenhouse gases has attracted great attention. Photocatalysis is an attractive approach to convert the greenhouse gases into fuel, as it not only stores solar energy but also directly consumes greenhouse gases. However, only photons above a band gap capable of exciting electron-hole pairs can be utilized, which inevitably results in low solar-to-fuel efficiency. Solar-driven thermochemical conversion of greenhouse gases has the potential to utilize a full spectrum of solar energy, thereby providing an opportunity for achieving high solar-to-fuel efficiency. However, both CO₂ and CH₄ are inert molecules featuring high dissociation energy and low polarity, so a high operating temperature above 800° C. is usually required to drive a dry reforming reaction from thermodynamic and kinetic perspective, which will inevitably lead to catalyst deactivation due to sintering of active metal sites and carbon deposition due to complete dissociation of CH₄ and disproportionate production of CO. In sharp contrast, solar-driven photothermal catalysis combines the low energy consumption of pure photocatalysis with a high reaction rate of thermal catalysis, thereby offering significant prospects for efficient and stable solar-driven dry reforming reactions.

### SUMMARY OF THE INVENTION

Objectives of the present disclosure: a first objective of the present disclosure is to provide a plasmonic nano-alloy photothermal-coupled methane dry reforming catalyst, which is capable of absorbing ultraviolet-visible light to reach a reaction temperature and excite high-energy hot electrons from active metals to reduce activation energy of the reaction, such that the photothermal-driven methane dry reforming for hydrogen production is realized; a second objective of the present disclosure is to provide a preparation method for the plasmonic nano-alloy photothermal-coupled methane dry reforming catalyst; and a third objective of the present disclosure is to provide application of the plasmonic nano-alloy photothermal-coupled methane dry reforming catalyst.

Technical solution: the plasmonic nano-alloy photothermal-coupled methane dry reforming catalyst in the present disclosure is NiCoZn/MgAlOₓ, which uses a magnesium-aluminum spinel as a carrier, and nickel, cobalt and zinc as active metal components. The carrier of magnesium-aluminum spinel, and the nickel-cobalt-zinc alloy produce a strong metal-support interaction, enhancing absorption and activation performance of CO₂. In the process of photothermal-driven methane dry reforming for hydrogen production, the catalyst exhibits high spectral absorption capacity in an ultraviolet-visible light range. Under the lighting of visible light, an addition of Zn promotes a high-energy hot electron injection induced by localized surface plasmon resonance, which activates a C—H bond of CH₄ and a C—O bond of CO₂, and can also inhibit complete cracking of CH₄, thereby avoiding the formation of carbon deposition, and enabling high-performance methane dry reforming under the conditions of focused lighting and heating. Under continuous introduction of reaction gases, stable and efficient photothermal-driven methane dry reforming can be achieved in a photothermal reactor.

Further, the active metal components account for 0.8%-10% of a mass of the carrier; and mass ratios of Ni, Co, and Zn in the catalyst are 7%-8%, 0.01%-8%, and 0.01%-1%, respectively.

The preparation method for the plasmonic nano-alloy photothermal-coupled methane dry reforming catalyst adopts a one-pot hydrothermal method to prepare an alloy catalyst NiCoZn/MgAlOₓ by using a magnesium-aluminum spinel as a carrier, and nickel, cobalt and zinc as active metal components, including the following steps:
further, specific steps for preparing the catalyst NiCoZn/MgAlOₓ are as follows:
(1) dissolving nickel salt, cobalt salt, zinc salt, magnesium salt, and aluminum salt in a solvent, and stirring to form a first solution;
(2) adding a sodium hydroxide solution to the first solution, and continuing to stir vigorously;
(3) performing continuous hydrothermal reaction with the solution stirred in the step (2) in a hydrothermal reactor;
(4) performing centrifugation and washing to obtain a precipitate, drying and grinding the precipitate to obtain a NiCoZn alloy magnesium-aluminum spinel catalyst precursor; and
(5) placing the NiCoZn alloy magnesium-aluminum spinel catalyst precursor in a tubular furnace under a mixed H₂/N₂ atmosphere, heating the precursor to a desired temperature and keeping the temperature for a period of time to ensure sample reduction, and then cooling to room temperature to obtain a catalyst NiCoZn/MgAlOₓ.

Further, in the step (1), a molar ratio of nickel salt, cobalt salt, zinc salt, magnesium salt, and aluminum salt falls within a range of 0-1:1:1:2:10.

Further, in the step (3), a temperature of the hydrothermal reaction is 120° C.-150° C., and the reaction lasts for 45-50 h.

Further, in the step (5), a heating rate is 2° C./min, a temperature is 600° C., and the temperature is kept for 2 h. The application of the plasmonic nano-alloy photothermal-coupled methane dry reforming catalyst is performed in a photothermal reactor and includes the following steps:
(1) placing the catalyst NiCoZn/MgAlOₓ in a reaction crucible;
(2) purging air in a pipeline of the reactor;
(3) turning on a xenon lamp to irradiate with ultraviolet-visible light, simulating sunlight for focused lighting, with light spots directly irradiating a surface of the catalyst NiCoZn/MgAlOₓ; and
(4) after absorbing high-energy photons, the catalyst NiCoZn/MgAlOₓ rapidly heats up to a desired reaction temperature and performs photothermal-coupled methane dry reforming for hydrogen production. The high-energy hot electron injection induced by localized surface plasmon resonance activates the C—H bond of CH₄ and the C—O bond of CO₂, and inhibits complete cracking of CH₄, thereby avoiding the formation of carbon deposition.

Further, for the method, methane, carbon dioxide, and nitrogen gas are introduced to purge the reactor before the reaction to replace impurities in the reactor; where the focused lighting comes from the xenon lamp and precisely covers the surface of catalyst. Under lighting, a plasmonic effect on the surface of catalyst promotes the reaction, achieving optimal photothermal coupled performance.

Beneficial effects: Compared with prior art, the present disclosure has the following significant advantages: compared with other control samples, the NiCoZn magnesium-aluminum spinel catalyst has improved the performance. On one hand, it increases the alkalinity of the catalyst, enhances absorption and activation capabilities of CO₂, and strengthens the metal-carrier interaction with the addition of Zn. On the other hand, the catalyst exhibits high spectral absorption capacity in an ultraviolet-visible light range and achieves the reaction temperature under focused light heating. Under the conditions of visible light, high-energy hot electrons are activated to pre-activate CH₄ and CO₂, reducing apparent activation energy of the reaction and realizing high-performance and long-term photothermal-driven methane dry reforming reaction.

### BRIEF DESCRIPTION OF THE DRAWINGS

FIG. 1 is a schematic diagram of hot electron excitation in a photothermal-driven methane dry reforming catalyst NiCoZn/MgAlOₓ.

FIG. 2 is a TEM electron microscope image of a photothermal-driven methane dry reforming catalyst NiCoZn/MgAlOₓ.

FIG. 3 is an XRD spectrum of a photothermal-driven methane dry reforming catalyst.

FIG. 4 is a comparison of comprehensive performance of a photothermal-driven methane dry reforming catalyst.

FIG. 5 is a comparison of a photothermal-coupled synthesis gas yield of a photothermal-driven methane dry reforming catalyst.

FIG. 6 is a stability diagram of a photothermal-driven methane dry reforming catalyst NiCoZn/MgAlOₓ.

FIG. 7 is an ultraviolet-visible-near-infrared spectrum absorption diagram of a photothermal-driven methane dry reforming catalyst.

FIG. 8 is a performance comparison of a photothermal-driven methane dry reforming catalyst under lighting of different light wavelengths.

FIG. 9 is a diagram showing main reaction energy barriers for methane dry reforming on different catalysts calculated by DFT.

FIG. 10 is a comparison of solar-to-fuel efficiency of methane dry reforming reaction for different ternary alloys.

### DETAILED DESCRIPTION OF THE EMBODIMENTS

The present disclosure will be further described below in conjunction with specific examples.

### Example 1

A preparation method for a plasmonic nano-alloy photothermal-coupled methane dry reforming catalyst, which is specifically prepared by the following method:
(1) 0.582 g of nickel nitrate hexahydrate, 0.582 g of cobalt nitrate hexahydrate, 1.19 g of zinc nitrate hexahydrate, 1.023 g of magnesium nitrate hexahydrate, and 7.5 g of aluminum nitrate nonahydrate were dissolved in 200 mL of deionized water, and stirred with a magnetic stirrer at room temperature for 30 min to form a first solution;
(2) 50 mL of 1.68 mol/L sodium hydroxide solution was added to the mixed solution obtained in the step (1), then sonicated and stirred vigorously for 4 h;
(3) the stirred solution in the step (2) was transferred into a polytetrafluoroethylene (PTEE)-lined container, which was then placed in a high-pressure reactor to react at 130° C. for 48 h;
(4) the mixed solution obtained after hydrothermal treatment in the step (3) was centrifuged at 6000 r/min to obtain a precipitate, the precipitate was then washed five times with water and ethanol;
(5) the precipitate obtained in the step (4) was dried at 80° C. overnight, then ground to obtain a NiCoZn alloy magnesium-aluminum spinel catalyst precursor; and
(6) the NiCoZn alloy magnesium-aluminum spinel catalyst precursor was placed in a tubular furnace of a 10% H₂ and 90% N₂ atmosphere at a heating rate of 2° C./min, heated up to 600° C. and kept for 2 h, and cooled with the furnace to room temperature to obtain a catalyst NiCoZn/MgAlOₓ.

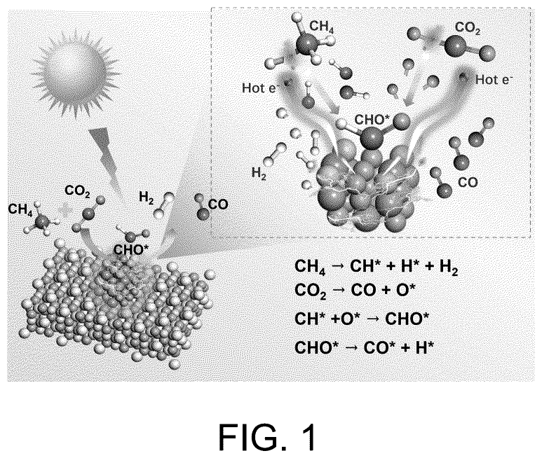

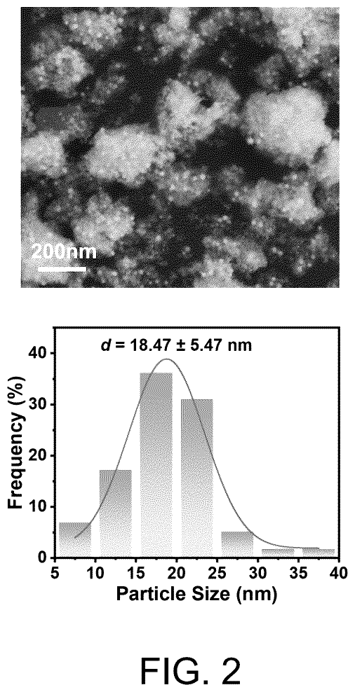

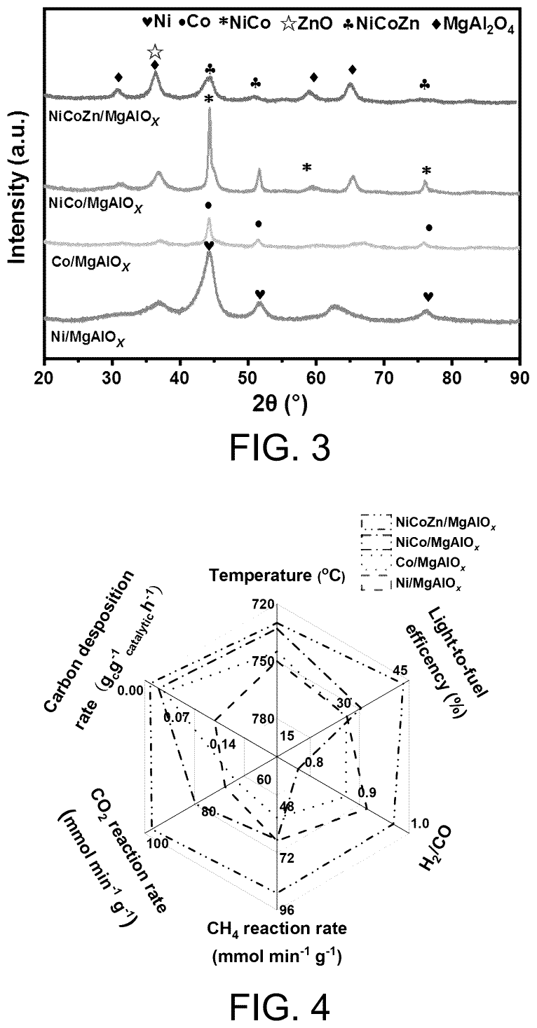

As shown in FIG. 1, hot electron injection induced by the localized surface plasmon resonance (LSPR) of the catalyst NiCoZn/MgAlOₓ activated a first C—H bond of CH₄ and a C—O bond of CO₂, further inducing the reaction. As shown in FIG. 2, nano-scale bright spots were NiCoZn metallic particle, with a particle size of approximately 18.5 nm. Combining with an XRD spectrum of the catalyst in FIG. 3, a catalyst carrier was magnesium-aluminum spinel, indicating that the prepared catalyst was the nickel-cobalt-zinc alloy catalyst (NiCoZn/MgAlOₓ), and had an amorphous structure.

### Example 2

A preparation method for a plasmonic nano-alloy photothermal-coupled methane dry reforming catalyst, which is specifically prepared by the following method:
(1) 0.582 g of nickel nitrate hexahydrate, 0.582 g of cobalt nitrate hexahydrate, 2.39 g of zinc nitrate hexahydrate, 1.023 g of magnesium nitrate hexahydrate, and 7.5 g of aluminum nitrate nonahydrate were dissolved in 200 mL of deionized water, and stirred with a magnetic stirrer at room temperature for 30 min to form a first solution;
(2) 50 mL of 1.83 mol/L sodium hydroxide solution was added to the mixed solution obtained in the step (1), then sonicated and stirred vigorously for 4 h;
(3) the stirred solution in the step (2) was transferred into a PTEE-lined container, which was then placed in a high-pressure reactor to react at 130° C. for 48 h;
(4) the mixed solution obtained after hydrothermal treatment in the step (3) was centrifuged at 6000 r/min to obtain a precipitate, the precipitate was then washed five times with water and ethanol;
(5) the precipitate obtained in the step (4) was dried at 80° C. overnight, then ground to obtain a NiCoZn alloy magnesium-aluminum spinel catalyst precursor; and
(6) the NiCoZn alloy magnesium-aluminum spinel catalyst precursor was placed in a tubular furnace of a 10% H₂ and 90% N₂ atmosphere at a heating rate of 2° C./min, heated up to 600° C. and kept for 2 h, and cooled with the furnace to room temperature to obtain a catalyst NiCoZn₂/MgAlOₓ.

### Comparative Example 1

A preparation method for a plasmonic nano-alloy photothermal-coupled methane dry reforming catalyst, which is specifically prepared by the following method:
(1) 0.582 g of nickel nitrate hexahydrate, 0.582 g of cobalt nitrate hexahydrate, 1.19 g of copper nitrate hexahydrate, 1.023 g of magnesium nitrate hexahydrate, and 7.5 g of aluminum nitrate nonahydrate were dissolved in 200 mL of deionized water, and stirred with a magnetic stirrer at room temperature for 30 min to form a first solution;
(2) 50 mL of 1.68 mol/L sodium hydroxide solution was added to the mixed solution obtained in the step (1), then sonicated and stirred vigorously for 4 h;
(3) the stirred solution in the step (2) was transferred into a polytetrafluoroethylene (PTEE)-lined container, which was then placed in a high-pressure reactor to react at 130° C. for 48 h;
(4) the mixed solution obtained after hydrothermal treatment in the step (3) was centrifuged at 6000 r/min to obtain a precipitate, the precipitate was then washed five times with water and ethanol;
(5) the precipitate obtained in the step (4) was dried at 80° C. overnight, then ground to obtain a NiCoCu magnesium-aluminum spinel catalyst precursor; and
(6) the NiCoCu magnesium-aluminum spinel catalyst precursor was placed in a tubular furnace of a 10% H₂ and 90% N₂ atmosphere at a heating rate of 2° C./min, heated up to 600° C. and kept for 2 h, and cooled with the furnace to room temperature to obtain a catalyst NiCoCu/MgAlOₓ.

### Comparative Example 2

A preparation method for a plasmonic nano-alloy photothermal-coupled methane dry reforming catalyst, which is specifically prepared by the following method:
(1) 1.164 g of nickel nitrate hexahydrate, 1.023 g of magnesium nitrate hexahydrate, and 7.5 g of aluminum nitrate nonahydrate were dissolved in 200 mL of deionized water, and stirred with a magnetic stirrer at room temperature for 30 min to form a first solution;
(2) 50 mL of 1.68 mol/L sodium hydroxide solution was added to the mixed solution obtained in the step (1), then sonicated and stirred vigorously for 4 h;
(3) the stirred solution in the step (2) was transferred into a polytetrafluoroethylene (PTEE)-lined container, which was then placed in a high-pressure reactor to react at 130° C. for 48 h;
(4) the mixed solution obtained after hydrothermal treatment in the step (3) was centrifuged at 6000 r/min to obtain a precipitate, the precipitate was then washed five times with water and ethanol;
(5) the precipitate obtained in the step (4) was dried at 80° C. overnight, then ground to obtain a Ni/Mg aluminum spinel catalyst precursor; and
(6) the Ni/Mg aluminum spinel catalyst precursor was placed in a tubular furnace of a 10% H₂ and 90% N₂ atmosphere at a heating rate of 2° C./min, heated up to 600° C. and kept for 2 h, and cooled with the furnace to room temperature to obtain a catalyst Ni/MgAlOₓ.

### Comparative Example 3

A preparation method for a plasmonic nano-alloy photothermal-coupled methane dry reforming catalyst, which is specifically prepared by the following method:
(1) 1.164 g of cobalt nitrate hexahydrate, 1.023 g of magnesium nitrate hexahydrate, and 7.5 g of aluminum nitrate nonahydrate were dissolved in 200 mL of deionized water, and stirred with a magnetic stirrer at room temperature for 30 min to form a first solution;
(2) 50 mL of 1.68 mol/L sodium hydroxide solution was added to the mixed solution obtained in the step (1), then sonicated and stirred vigorously for 4 h;
(3) the stirred solution in the step (2) was transferred into a polytetrafluoroethylene (PTEE)-lined container, which was then placed in a high-pressure reactor to react at 130° C. for 48 h;
(4) the mixed solution obtained after hydrothermal treatment in the step (3) was centrifuged at 6000 r/min to obtain a precipitate, the precipitate was then washed five times with water and ethanol;
(5) the precipitate obtained in the step (4) was dried at 80° C. overnight, then ground to obtain a Co/Mg aluminum spinel catalyst precursor; and
(6) the Co/Mg aluminum spinel catalyst precursor was placed in a tubular furnace of a 10% H₂ and 90% N₂ atmosphere at a heating rate of 2° C./min, heated up to 600° C. and kept for 2 h, and cooled with the furnace to room temperature to obtain a catalyst Co/MgAlOₓ.

### Comparative Example 4

A preparation method for a plasmonic nano-alloy photothermal-coupled methane dry reforming catalyst, which is specifically prepared by the following method:
(1) 0.582 g of nickel nitrate hexahydrate, 0.582 g of cobalt nitrate hexahydrate, 1.023 g of magnesium nitrate hexahydrate, and 7.5 g of aluminum nitrate nonahydrate were dissolved in 200 mL of deionized water, and stirred with a magnetic stirrer at room temperature for 30 min to form a first solution;
(2) 50 mL of 1.68 mol/L sodium hydroxide solution was added to the mixed solution obtained in the step (1), then sonicated and stirred vigorously for 4 h;
(3) the stirred solution in the step (2) was transferred into a polytetrafluoroethylene (PTEE)-lined container, which was then placed in a high-pressure reactor to react at 130° C. for 48 h;
(4) the mixed solution obtained after hydrothermal treatment in the step (3) was centrifuged at 6000 r/min to obtain a precipitate, the precipitate was then washed five times with water and ethanol;
(5) the precipitate obtained in the step (4) was dried at 80° C. overnight, then ground to obtain a NiCo alloy aluminum spinel catalyst precursor; and
(6) the NiCo alloy aluminum spinel catalyst precursor was placed in a tubular furnace of a 10% H₂ and 90% N₂ atmosphere at a heating rate of 2° C./min, heated up to 600° C. and kept for 2 h, and cooled with the furnace to room temperature to obtain a catalyst NiCo/MgAlOₓ.

Photothermal-driven methane dry reforming for hydrogen production was performed in a photothermal reactor, and the catalyst was placed in a special reaction crucible. During the reaction, a mixed gas of methane, carbon dioxide and nitrogen was continuously introduced into a pipeline, a xenon lamp was then turned on to irradiate a surface of the catalyst with ultraviolet-visible light, in which case, the catalyst absorbed high-energy photons to reach a reaction temperature for photothermal-coupled methane dry reforming to produce hydrogen.

An activity test of the catalyst for photothermal-driven methane dry reforming to produce hydrogen was, and the test includes the following steps:
(1) 0.014 g of catalyst was weighed and placed into a reaction crucible;
(2) a mixed gas of methane, carbon dioxide and nitrogen was continuously introduced into a pipeline of the reactor to purge the air in the pipeline;
(3) a volume ratio of methane, carbon dioxide, and nitrogen before being introduced into the reactor was 41.8%/43.2%/17.8%, and a total flow rate of the mixed gas was 101 ml/min;
(4) a xenon lamp was turned on to irradiate with ultraviolet-visible light, sunlight was simulated for focused lighting, with a light intensity of 11.6 W, a light spot size of 6 mm, directly irradiating a surface of the catalyst Ni/MgAlOₓ;
(5) after absorbing high-energy photons, the Ni/MgAlOₓ catalyst rapidly heated up to a required reaction temperature;
(6) photothermal-coupled methane dry reforming was carried out to produce hydrogen; and
(7) a reaction gas was introduced into a gas chromatograph for analysis; a yield of H₂ was 118.2 mmol/min/g_{cat}, and a yield of CO was 128.4 mmol/min/g_{cat}.

Gas chromatograph detection and subsequent calculations indicated that the catalyst used in Example 1 for photothermal-coupled methane dry reforming for hydrogen production had a yield of H₂ up to 173.6 mmol/min/g_{cat} and a yield of CO up to 178.6 mmol/min/g_{cat}. The catalyst used in Comparative Example 3 for photothermal-coupled methane dry reforming for hydrogen production had a yield of H₂ up to 94 mmol/min/g_{cat} and a yield of CO up to 108 mmol/min/g_{cat}.

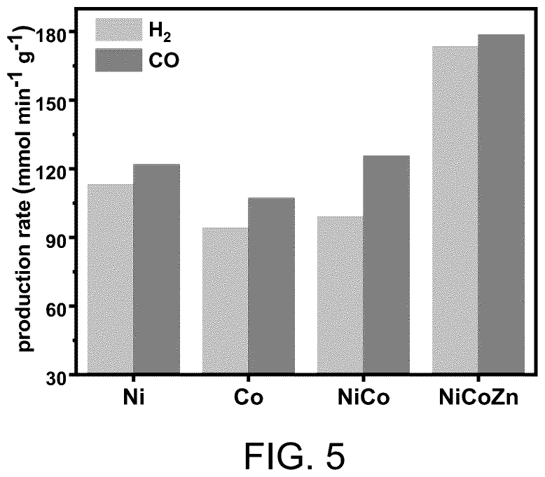

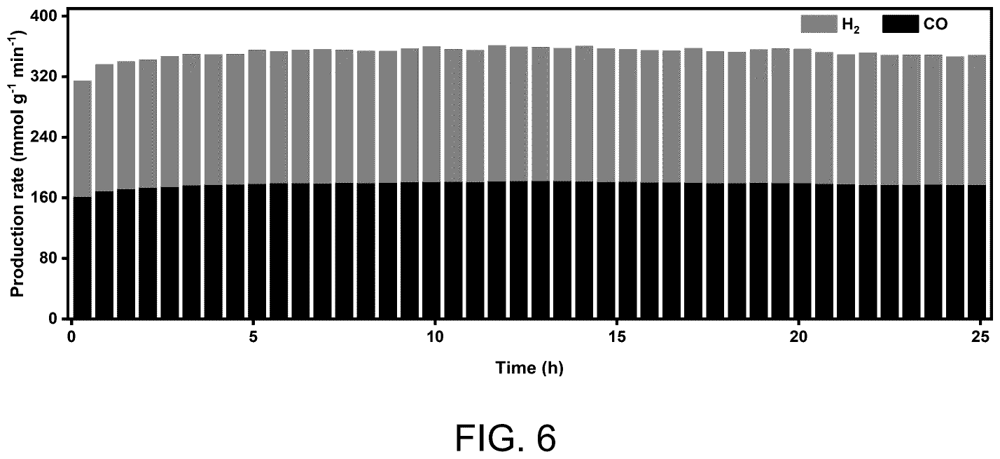

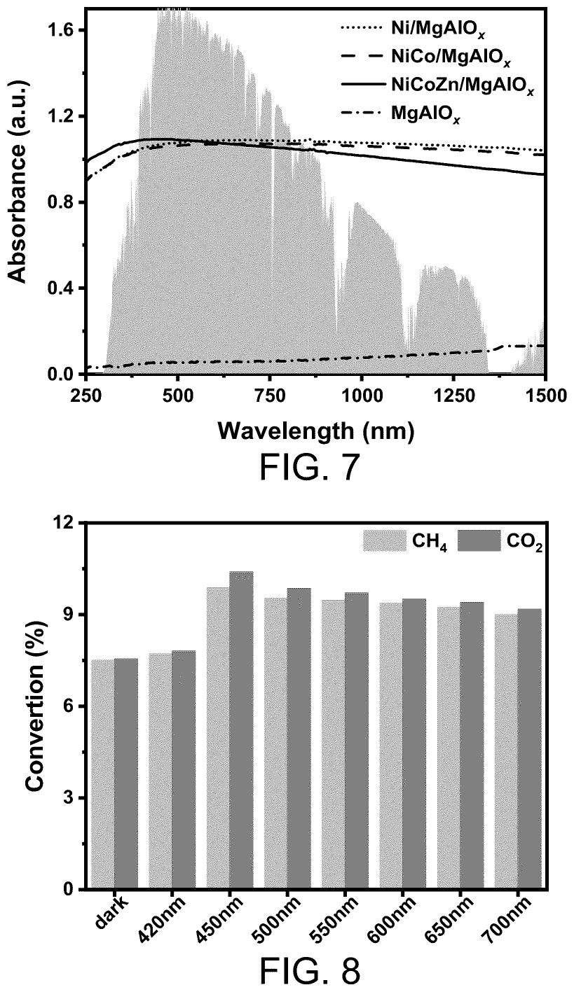

As shown in FIGS. 4-5, the Ni, Co, and Zn loadings in the catalyst prepared in Example 1 were 6.7%, 7.3%, and 0.87%, respectively, the synthesized catalyst NiCoZn/MgAlOₓ exhibited great advantages in terms of reaction gas conversion rate, carbon deposition resistance, hydrogen-carbon monoxide ratio, solar-to-fuel efficiency, and the like when a molar ratio of Mg:Al was 1:5. The catalyst also had excellent stability during the reaction (FIG. 6). In addition, as shown in FIGS. 7-8, the catalyst had strong light absorption capabilities, particularly in a visible light range of 450 nm, offering excellent light absorption and catalytic performance, which was attributed to hot electrons generated by the plasmonic effect of the catalyst NiCoZn/MgAlOₓ under lighting at the wavelength, promoting the dry reforming reaction, and providing theoretical guidance for future photothermal coupling experiments.

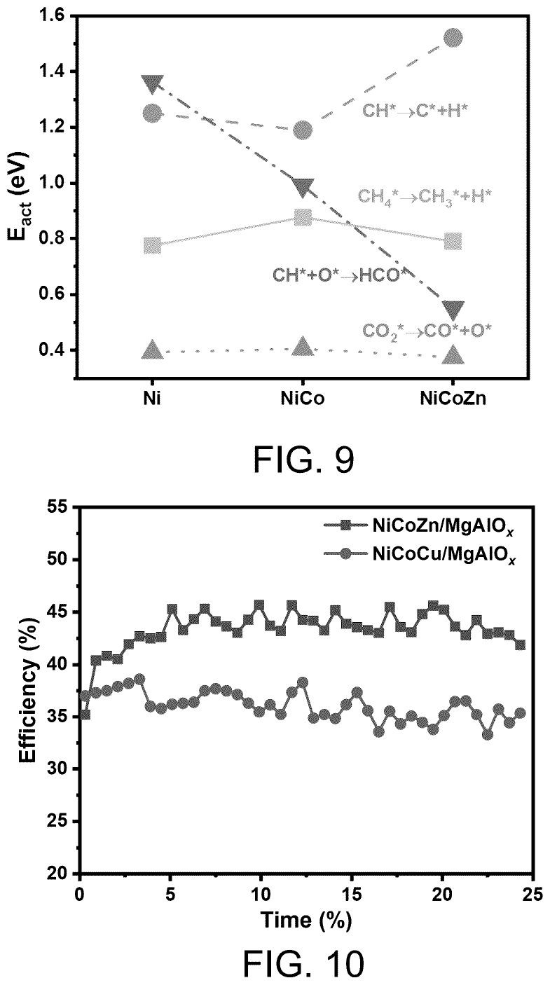

As shown in FIG. 9, DFT calculations indicated that the NiCoZn ternary alloy had significant advantages in the main reactions of methane dry reforming, effectively activated the reactant molecules CH₄ and CO₂, had lower activation energy for breaking the C—H bond, and exhibited higher activation energy in a final step of CH₄ cleavage, which could inhibit the carbon deposition caused by methane cracking and promote the orderly steps of the reaction to CH oxidation. In addition, as shown in FIG. 10, the catalytic results of the same ternary nano-alloy catalyst indicated that the light-fuel conversion efficiency of NiCoZn/MgAlOₓwas significantly higher than that of NiCoCu/MgAlOₓ, proving that the addition of Zn greatly had great advantages in the catalytic performance of the catalyst for methane dry reforming.

What is claimed is:

1. A plasmonic nano-alloy photothermal-coupled methane dry reforming catalyst, wherein the catalyst is a catalyst NiCoZn/MgAlOₓ, in which the catalyst NiCoZn/MgAlOₓ uses a magnesium-aluminum spinel as a carrier, and nickel, cobalt and zinc as active metal components; and in a process of photothermal-driven methane dry reforming for hydrogen production, an addition of zinc promotes a high-energy hot electron injection induced by localized surface plasmon resonance, which activates a C—H bond of CH₄ and a C—O bond of CO₂ and inhibits complete cracking of CH₄, thereby avoiding a formation of carbon deposition.

2. The plasmonic nano-alloy photothermal-coupled methane dry reforming catalyst according to claim 1, wherein the active metal components account for 0.8%-10% of a mass of the carrier; and mass ratios of nickel, cobalt, and zinc in the catalyst NiCoZn/MgAlOₓ are 7%-8%, 0.01%-8%, and 0.01%-1%, respectively.

3. A preparation method for the plasmonic nano-alloy photothermal-coupled methane dry reforming catalyst according to claim 1, comprising the following steps:
(1) dissolving nickel salt, cobalt salt, zinc salt, magnesium salt, and aluminum salt in a solvent, and stirring to form a first solution;
(2) adding a sodium hydroxide solution to the first solution to obtain a mixed solution, and continuing to stir vigorously;
(3) performing a continuous hydrothermal reaction with the mixed solution stirred in the step (2) in a hydrothermal reactor;
(4) performing centrifugation and washing to obtain a precipitate, drying and grinding the precipitate to obtain a NiCoZn alloy magnesium-aluminum spinel catalyst precursor; and
(5) placing the NiCoZn alloy magnesium-aluminum spinel catalyst precursor in a tubular furnace under a mixed H₂/N₂ atmosphere, heating the NiCoZn alloy magnesium-aluminum spinel catalyst precursor to a desired temperature and keeping the desired temperature for a period of time to ensure sample reduction, and then cooling to room temperature to obtain the catalyst NiCoZn/MgAlOₓ.

4. The preparation method for the plasmonic nano-alloy photothermal-coupled methane dry reforming catalyst according to claim 3, wherein in the step (1), a molar ratio of nickel salt, cobalt salt, zinc salt, magnesium salt, and aluminum salt falls within a range of 0-1:1:1:2:10.

5. The preparation method for the plasmonic nano-alloy photothermal-coupled methane dry reforming catalyst according to claim 3, wherein in the step (3), a temperature of the continuous hydrothermal reaction is 120° C.-150° C., and the continuous hydrothermal reaction lasts for 45-50 hours.

6. The preparation method for the plasmonic nano-alloy photothermal-coupled methane dry reforming catalyst according to claim 3, wherein in the step (5), a rate of the heating is 2° C./min, the desired temperature is 600° C., and the desired temperature is kept for 2 h.

7. Application of the plasmonic nano-alloy photothermal-coupled methane dry reforming catalyst according to claim 1 in photothermal-driven methane dry reforming for hydrogen production.

8. The application of the plasmonic nano-alloy photothermal-coupled methane dry reforming catalyst in photothermal-driven methane dry reforming for hydrogen production according to claim 7, wherein the application is performed in a photothermal reactor and comprises the following steps:
(1) placing the catalyst NiCoZn/MgAlOₓ in a reaction crucible for a methane dry reforming reaction;
(2) purging air in a pipeline of the photothermal reactor;
(3) turning on a xenon lamp to irradiate with ultraviolet-visible light, simulating sunlight for focused lighting, with light spots directly irradiating a surface of the catalyst NiCoZn/MgAlOₓ; and
(4) injecting high-energy hot electrons induced by localized surface plasmon resonance of the catalyst NiCoZn/MgAlOₓ under lighting, activating the C—H bond of CH₄ and the C—O bond of CO₂, inhibiting complete cracking of CH₄ and avoiding a formation of carbon deposition.

9. The application of the plasmonic nano-alloy photothermal-coupled methane dry reforming catalyst in photothermal-driven methane dry reforming for hydrogen production according to claim 8, wherein methane, carbon dioxide, and nitrogen gas are introduced to purge the photothermal reactor before the methane dry reforming reaction to replace impurities in the photothermal reactor.

10. The application of the plasmonic nano-alloy photothermal-coupled methane dry reforming catalyst in photothermal-driven methane dry reforming for hydrogen production according to claim 8, wherein the focused lighting comes from the xenon lamp and precisely covers the surface of the catalyst NiCoZn/MgAlOₓ; and under the lighting, a plasmonic effect on the surface of the NiCoZn/MgAlOₓ catalyst promotes the methane dry reforming reaction, thereby achieving optimal photothermal coupled performance.
